(19) United States
(12) Patent Application Publication
(10) Pub. No.: US 2024/0249523 A1
(43) Pub. Date: Jul. 25, 2024

(54) Systems and Methods for Identifying and Extracting Object-Related Effects in Videos

(71) Applicant: Google LLC, Mountain View, CA (US)

(72) Inventors: Forrester H. Cole, Cambridge, MA (US); Andrew Zisserman, Oxford (GB); Tali Dekel, Arlington, MA (US); William Tafel Freeman, Acton, MA (US); Erika Lu, Lexington, MA (US); Michael Rubinstein, Natick, MA (US)

(21) Appl. No.: 18/560,609

(22) PCT Filed: May 11, 2022
(86) PCT No.: PCT/US2022/028804

§ 371 Date: Nov. 13, 2023

Related U.S. Application Data
(60) Provisional application No. 63/186,971, filed on May 11, 2021.

(51) Int. Cl. G06V 20/40; G06T 7/194; G06T 7/246; G06T 7/73; G06V 10/26; G06V 10/776; G06V 10/82

(52) U.S. Cl. CPC G06V 20/46; G06T 7/194; G06T 7/246; G06T 7/73; G06V 10/26; G06V 10/776; G06V 10/82; G06T 2207/10016; G06T 2207/10024; G06T 2207/20081; G06T 2207/20084

(57) ABSTRACT

The present disclosure provides systems and methods for identifying and extracting object-related effects in videos. Given an ordinary video and a rough segmentation mask overtime of one or more subjects of interest, example systems proposed herein can estimate an omnimatte for each subject—an alpha matte and color image that includes the subject along with all its related time-varying scene elements. Example implementations of the proposed models can be trained only on the input video in a self-supervised manner, without any manual labels, and are generic. For example, the models can produce omnimattes automatically for arbitrary objects and a variety of effects.

### RELATED APPLICATIONS

This application claims priority to and the benefit of U.S. Provisional Patent Application No. 63/186,971, filed May 11, 2021. U.S. Provisional Patent Application No. 63/186,971 is hereby incorporated by reference in its entirety.

### FIELD

The present disclosure relates generally to image processing. More particularly, the present disclosure relates to systems and methods for identifying and extracting object-related effects in videos.

### BACKGROUND

Computer vision is increasingly effective at segmenting objects in images and videos. However, scene effects related to the objects—shadows, reflections, generated smoke, etc.—are typically overlooked. Identifying such scene effects and associating them with the objects producing them is important for improving our fundamental understanding of visual scenes, and can also assist a variety of applications such as removing, duplicating, or enhancing objects in video.

### SUMMARY

Aspects and advantages of embodiments of the present disclosure will be set forth in part in the following description, or can be learned from the description, or can be learned through practice of the embodiments.

One example aspect of the present disclosure is directed to a computer-implemented method for identifying and extracting object-related effects in videos, the computer-implemented method comprising: obtaining, by a computing system comprising one or more computing devices, video data, the video data comprising a plurality of image frames depicting one or more objects; and for each of the plurality of image frames: generating, by the computing system, one or more binary object masks, wherein each of the one or more binary object masks is descriptive of a respective location of a corresponding object of the one or more objects within the image frame; inputting, by the computing system, the image frame and the one or more binary object masks into a machine-learned matte generation model; and receiving, by the computing system as output from the machine-learned matte generation model, a background layer illustrative of a background of the video data and one or more object layers respectively associated with the one or more binary object masks; wherein each of the one or more object layers comprises image data illustrative of the corresponding object and one or more trace effects at least partially attributable to the corresponding object.

In some implementations, the background layer and the one or more object layers comprise one or more color channels and an opacity matte.

In some implementations, for each corresponding object, at least a portion of the one or more trace effects have locations which different from the respective location of the corresponding object.

In some implementations, for each corresponding object, at least a portion of the one or more trace effects are time-varying effects.

In some implementations, each of the one or more binary object masks is descriptive of the respective location of the corresponding object independent of and excluding the one or more trace effects.

In some implementations, for at least one of the corresponding objects, the one or more trace effects comprise a shadow, a reflection, smoke generated by the object, or a ripple.

In some implementations, the method further comprise, for each of the plurality of image frames: generating, by the computing system and based at least in part on the one or more binary object masks, one or more object optical flows respectively for the one or more objects; wherein inputting, by the computing system, the image frame and the one or more binary object masks into the machine-learned matte generation model comprises wherein inputting, by the computing system, the image frame, the one or more binary object masks, and the one or more object optical flows into the machine-learned matte generation model.

In some implementations, each of the one or more object layers comprises a refined object optical flow for the corresponding object.

In some implementations, at least one of the corresponding objects comprises a plurality of objects treated as a collective object.

In some implementations, the machine-learned matte generation model comprises a neural network.

In some implementations, the machine-learned matte generation model has been trained based at least in part on a reconstruction loss, a flow loss, and a regularization loss.

Another example aspect is directed to a computing system configured to decompose image data into a plurality of layers. The computing system includes one or more processors; and one or more non-transitory computer-readable media that store instructions that, when executed by the one or more processors, cause the computing system to perform operations. The operations include: obtaining image data, the image data comprising one or more image frames depicting one or more objects; and for each of the one or more image frames: generating one or more binary object masks, wherein each of the one or more binary object masks is descriptive of a respective location of corresponding object of the one or more objects within the image frame; inputting the image frame and the one or more binary object masks into a machine-learned matte generation model; and receiving, as output from the machine-learned matte generation model, a background layer illustrative of a background of the image data and one or more object layers respectively associated with one of the one or more binary object masks; wherein each of the one or more object layers comprises image data illustrative of the corresponding object and one or more trace effects at least partially attributable to the corresponding object.

In some implementations, the background layer and the one or more object layers comprise one or more color channels and an opacity matte.

In some implementations, for each corresponding object, at least a portion of the one or more trace effects have locations which different from the respective location of the corresponding object.

In some implementations, for at least one of the corresponding objects, the one or more trace effects comprise a shadow, a reflection, smoke generated by the object, or a ripple.

Another example aspect is directed to one or more non-transitory computer-readable media that collectively store a machine-learned matte generation model, wherein the machine-learned matte generation model has been trained by performance of operations. The operations include obtaining, by a computing system comprising one or more computing devices, video data, the video data comprising a plurality of image frames depicting one or more objects; and for each of the plurality of image frames: generating, by the computing system, one or more binary object masks, wherein each of the one or more binary object masks is descriptive of a respective location of a corresponding object of the one or more objects within the image frame; inputting, by the computing system, the image frame and the one or more binary object masks into a machine-learned matte generation model; receiving, by the computing system as output from the machine-learned matte generation model, a background layer illustrative of a background of the video data and one or more object layers respectively associated with the one or more binary object masks, wherein each of the one or more object layers comprises image data illustrative of the corresponding object and one or more trace effects at least partially attributable to the corresponding object; compositing the background layer and the one or more object layers to generate a reconstructed frame; evaluating a loss function that comprises a reconstruction loss term that compares the reconstructed frame with the image frame; and modifying one or more values of one or more parameters of the machine-learned matte generation model based on the loss function.

In some implementations, the background layer and the one or more object layers comprise one or more color channels and an opacity matte.

In some implementations, for each of the plurality of image frames: the operations further comprise generating, by the computing system and based at least in part on the one or more binary object masks, one or more object optical flows respectively for the one or more objects; inputting, by the computing system, the image frame and the one or more binary object masks into the machine-learned matte generation model comprises wherein inputting, by the computing system, the image frame, the one or more binary object masks, and the one or more object optical flows into the machine-learned matte generation model; each of the one or more object layers comprises a refined object optical flow for the corresponding object; the operations further comprise compositing the refined object optical flows to generate a reconstructed flow map; and the loss function further comprises a flow loss term that compares an original flow map with the reconstructed flow map.

In some implementations, the loss function further comprises an alpha warping loss term that compares an opacity matte of each object layer with a warped opacity matte for such object layer, the warped opacity matte for each object layer comprises a previous or subsequent opacity matte associated with the object layer in a previous or subsequence image frame which has been warped according to the refined object optical flow generated for such object layer.

In some implementations, the loss function further comprises a regularization loss term that encourages an opacity matte of each object layer toward sparsity.

These and other features, aspects, and advantages of various embodiments of the present disclosure will become better understood with reference to the following description and appended claims. The accompanying drawings, which are incorporated in and constitute a part of this specification, illustrate example embodiments of the present disclosure and, together with the description, serve to explain the related principles.

### BRIEF DESCRIPTION OF THE DRAWINGS

Detailed discussion of embodiments directed to one of ordinary skill in the art is set forth in the specification, which makes reference to the appended figures, in which:

FIG. 1 depicts a graphical representation of an example process to associate objects with their effects in video according to example embodiments of the present disclosure.

FIG. 2 depicts a graphical diagram of an example machine learning model and pipeline to associate objects with their effects in video according to example embodiments of the present disclosure.

FIG. 3A depicts a block diagram of an example computing system according to example embodiments of the present disclosure.

FIG. 3B depicts a block diagram of an example computing device according to example embodiments of the present disclosure.

FIG. 3C depicts a block diagram of an example computing device according to example embodiments of the present disclosure.

### DETAILED DESCRIPTION

### Overview

The present disclosure provides systems and methods that solve the problem of automatically associating objects with their effects in video. Given an ordinary video and a rough segmentation mask over time of one or more subjects of interest, example systems proposed herein can estimate an omnimatte for each subject—an alpha matte and color image that includes the subject along with all its related time-varying scene elements. Example implementations of the proposed models can be trained only on the input video in a self-supervised manner, without any manual labels, and are generic. For example, the models can produce omnimattes automatically for arbitrary objects and a variety of effects. The proposed models are applicable to, among other inputs, real-world videos containing interactions between different types of subjects (cars, animals, people) and complex effects, ranging from semi-transparent elements such as smoke and reflections, to fully opaque effects such as objects attached to the subject.

More particularly, example systems of the present disclosure seek to determine all the effects caused by a subject in a video. This is a particularly difficult task: a subject, such as a human wandering through a scene, can cast shadows on the floor and distant walls, and be reflected in windows and other surfaces. These ‘effects’ are non-local. However, they are correlated with the subject's shape, motion and, in the case of reflections, appearance.

Example implementations of the present disclosure provide solutions to this problem. More specifically, given an input video and (possibly rough) segmentations over time of subjects of interest in the video, example systems of the present disclosure can produce an output opacity matte (alpha matte) for each subject that includes the subject and their effects in the scene. This can be referred to as the “omnimatte” of the subject. Some example implementations additionally produce a color background image containing the static background elements in the video. In some implementations, this can be achieved using a network and training framework that is able to automatically determine and segment regions that are correlated with the given subject. The model can be trained in a self-supervised way only on the input video, without observing any additional examples. Further, unlike some existing approaches, certain implementations of the present disclosure rely only on binary input masks (i.e., no object-specific representation or processing) and incorporate general optical flow to account for motion and frame-to-frame correspondence.

Associating objects with their effects not only improves the fundamental understanding of visual scenes and events captured in video, it can also support a range of applications. Consider for example the problem of removing a person or other types of objects from a video. As is well known, a common error in person removal, e.g., by inpainting, is that a shadow or reflection of the person remains, resulting in a video left with just a shadow of the removed person. Thus, manipulating an object in a video requires dealing not only with the object; its effects in the scene need to be adjusted together with the object in order to create realistic and faithful renditions.

Therefore, example implementations of the present disclosure can infer omnimattes for different objects such as animals, cars, and people, capturing a variety of complex scene effects including shadows, reflections, dust and smoke. These omnimattes can be useful for video editing applications such as object removal, background replacement, “color pop”, and stroboscopic photography.

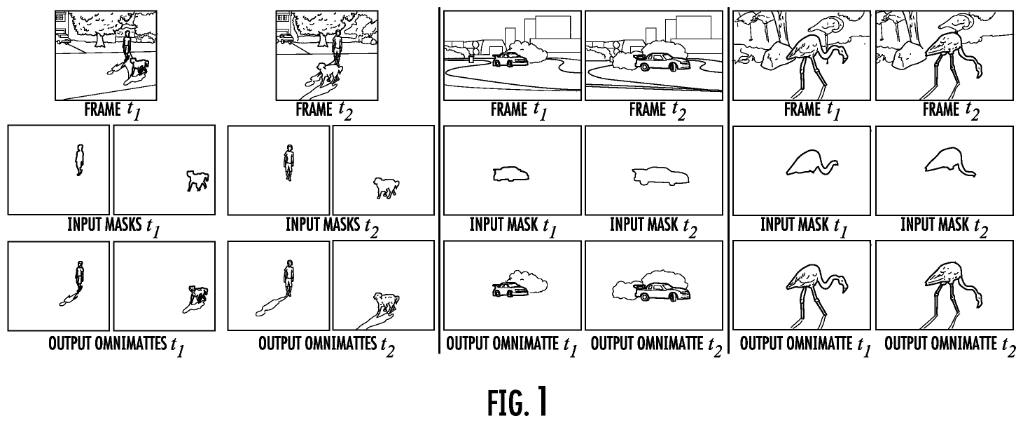

FIG. 1 shows an overview of an example process for resolving the novel problem of automatically associating subjects in videos with ‘effects’ related to them in the scene. Given an input video (top) and rough masks of subjects of interest (middle), the example proposed method estimates an omnimatte—an alpha matte and foreground color that includes the subject itself along with all scene elements associated with it (bottom). The associated elements can be other objects attached to the subject or moving with it, or complex effects such as shadows, reflections, smoke, or ripples the subject creates in water.

The systems and methods of the present disclosure provide a number of technical effects and benefits. As one example, the proposed techniques enable improved image or video processing. For example, as compared to manual editing, the proposed approaches can operate faster, thereby conserving computational resources such as memory space, processor cycles, and network bandwidth. As compared to prior automatic approaches, the quality of object removal or other operations can be improved, thereby resulting in an improvement to the functionality of the computer itself.

### Example Techniques for Estimating Omnimattes from Video

In some implementations, the input to the proposed method is an ordinary video of moving objects, and one or more layers of rough segmentation masks that mark the subjects of interest. The output is an omnimatte for each input mask layer, which can include an alpha matte (opacity map) and a color image. The model can be trained per-video to reconstruct the input in a self-supervised manner, without observing any additional examples.

To accurately reconstruct the input video, the model must infer all the time-varying effects (e.g., shadows, reflections) from the input object masks, which do not represent those effects. The goal is to steer the model to place the associated effects in the layer of the subject causing them. This association can be achieved by showing the network one mask at a time, leveraging the fact that an effect is easier to predict from the object mask most correlated with it. For example, the mask of the person in FIG. 1 provides more information about its shadow (more similar to it in shape, in motion) compared to the mask of the dog. Therefore the network tends to learn to predict the person's shadow from the person's mask (thus associating it with the correct layer). Example implementations of the present disclosure build on this training strategy, but design network inputs and losses to encourage this solution for general objects.

### Example Overview

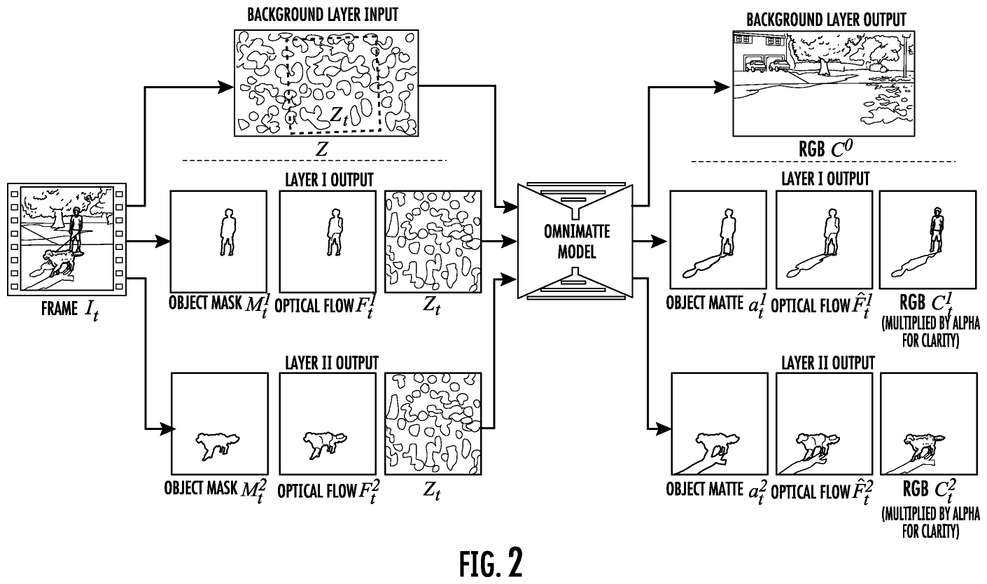

FIG. 2 illustrates a graphical diagram of one example pipeline. The input to the model is an ordinary video with multiple moving objects, and a rough segmentation mask M for each object (left). In a pre-processing step, an optical flow field F is computed between consecutive frames. For each object, the mask, estimated flow in the object's region, and a sampled noise image Zₜ (representing the background) can be provided or input to the model. The model can produce an omnimatte (color+opacity) and an optical flow field for the object (right). In addition, the model can predict a background color image for the entire video (top), given a spatial texture noise image Z̅ as input.

One example model that can be used in the example pipeline shown in FIG. 2 is a 2D U-Net that processes the video frame by frame. For each frame, rough object masks can be computed using off-the-shelf techniques to mark the major moving objects in the scene. The objects can be grouped into N mask layers {Mₜⁱ}ᵢ₌₁^{N}. A (possibly time-varying) ordering oₜ can be defined for the layers. For example, in a scene with a rider, a bicycle, and several people in a crowd, the rider and bicycle might be grouped into one layer, while the crowd is grouped into a second layer. To equip the proposed model with explicit information about object motion and frame-to-frame correspondence, a dense optical flow field, Fₜ, can be computed between each frame and the consecutive frame in the video. This flow field can be masked by the input masks Mₜⁱ to provide the network only flow information related to the layer's subject. Additionally, all frames can be aligned onto a common coordinate system using homographies. The background can be represented as a single unwrapped image on a separate layer.

From this rough yet explicit representation of moving objects, the model has to infer: (i) omnimattes—pairs of continuous-valued opacity maps (mattes) and RGB images that capture not only the i^{th} moving object but also all the scene elements that are correlated with it in space and time (e.g., reflections, shadows, attached objects, etc.), (ii) a refined optical flow field for each layer, and (iii) a background RGB image. Formally,

$$Omnimatte ( {I}_{t} , {H}_{t} , {M}_{t}^{i} , {F}_{t}^{i} ) = {ℒ}_{t} = \{ {α}_{t}^{i} , {C}_{t}^{i} , {\hat{F}}_{t}^{i} \} , \qquad ( 1 )$$

where Iₜ, Hₜ, Mₜⁱ, Fₜⁱ are the input video RGB frame, estimated camera homography, the initial input mask, and the pre-computed flow field of the i^{th} object in time t, respectively. αₜⁱ and Cₜⁱ are the alpha and color buffers of the output omnimatte, and \hat{F}ₜⁱ is the predicted object flow.

In some implementations, the training loss can include terms on the RGBA outputs and the predicted flow. The main loss can be a reconstruction loss E_{rgb-recon}, but as reconstruction is underconstrained with multiple layers, some example implementations can add a sparsity regularization E_{reg} to the alpha layers and an initialization loss Eₘₐₛₖ to the masks. The motion of the result can be encouraged to match the input by adding a flow-reconstruction loss E_{now-recon} and a temporal consistency term to the alpha mattes E_{alpha-warp}.

One example total loss is then:

$${E}_{rgb - recon} + {λ}_{r} {E}_{reg} + {λ}_{m} {E}_{mask} + {E}_{flow - recon} + {λ}_{w} {E}_{alpha - warp} , \qquad ( 2 )$$

where λᵣ, λₘ, and λ_{w} are weighting coefficients. As the background is assumed to be static, some implementations factor out camera motion and treat the background with a special, fixed layer.

### Example RGBA Losses

In some implementations, a main loss in the optimization is a reconstruction loss. Formally, the set of estimated layers for each frame and the predicted background layer can be composited using standard back-to-front compositing. The loss can encourage the composite image to match the original frame:

$${E}_{rgb - recon} = \frac{1}{T} {\sum }_{t} {‖ {I}_{t} - Comp ( {ℒ}_{t} , {o}_{t} ) ‖}_{1} , \qquad ( 3 )$$

where [symbol] ₜ={αₜⁱ, Cₜⁱ}ᵢ₌₁^{N} are the predicted layers for frame t, and oₜ is the compositing order.

To prevent a trivial solution where a single layer reconstructs the entire frame, some example implementations further apply a regularization loss to the αₜⁱ to encourage them to be spatially sparse. Some example implementations use a mix of L₁ and an approximate-L₀:

$${E}_{reg} = \frac{1}{T} \frac{1}{N} {\sum }_{t} {\sum }_{i} γ {‖ {α}_{t}^{i} ‖}_{1} + {Φ}_{0} ( {α}_{t}^{i} ) , \qquad ( 4 )$$

where Φ₀(x)=2·Sigmoid(5×)−1 smoothly penalizes non-zero values of the alpha map, and γ controls the relative weight between the terms.

To guide the optimization to convergence from a random initialization, some example implementations therefore adopt a “bootstrap” loss to coerce the alpha maps αₜⁱ to match the input masks Mₜⁱ:

$${E}_{mask} = \frac{1}{T} \frac{1}{N} {\sum }_{t} {\sum }_{i} {‖ {d}_{t}^{i} e ( {M}_{t}^{i} - {α}_{t}^{i} ) ‖}_{2} \qquad ( 5 )$$

where dₜⁱ=1·dilate(Mₜⁱ)+Mₜⁱ is a boundary erosion mask to turn off the loss near the mask boundary, and e is element-wise product. This loss is turned off after its value reaches a fixed threshold.

### Example Flow Losses

In some example implementations, the model additionally predicts a set of flow layers. Predicting flow layers serves as an auxiliary task that injects information about motion to our model and improves our decomposition (as demonstrated by our experiments). To achieve that, some example implementations apply a flow reconstruction loss and a photometric warping loss defined below:

$${E}_{flow - recon} = \frac{1}{T} {\sum }_{t} {W}_{t} \cdot {‖ {F}_{t} - Comp ( {ℱ}_{t} , {o}_{t} ) ‖}_{1} , \qquad ( 6 )$$

where [symbol] ₜ={\hat{F}ᵢ^{t}} is the set of predicted flow layers, Fₜ is the original, pre-computed flow, and Wₜ is a spatial weighting map that lowers the impact of pixels with inaccurate flow. Wₜ is computed based on standard left-right flow consistency error and photometric warping error (see full details in SM).

Some example implementations additionally encourage temporal consistency within layers using an alpha warping loss:

$${E}_{alpha - warp} = \frac{1}{T} \frac{1}{N} {\sum }_{t} {\sum }_{i} {‖ {α}_{t}^{i} - {α}_{wt}^{i} ‖}_{1} , \qquad ( 7 )$$

where α_{wt}ⁱ=Warp(αₜ₊₁ⁱ, [symbol] ₜⁱ) is the alpha for layer i at time t+1 warped to time t using the predicted flow.

### Example Camera Motion and Background

Some example implementations assume the background scene is stationary and camera motion can be modeled by a time-varying homography from an unwrapped “canvas” image. The homographies Hₜ from frame t to the canvas can be estimated via feature tracking on the original RGB video frames and are held fixed. For input to the network, the background canvas can be represented by a single spatial noise image Z (see FIG. 2). The background color layers Cₜ⁰ can be produced by feeding Z through the network to form a static color image C̅ₜ⁰, which can then be sampled using Hₜ⁻¹ to form time-varying background images {Cₜ⁰}.

To make the foreground layers aware of the camera motion, the input mask layers Mₜⁱ can be concatenated with a noise image that tracks the camera. The background noise image Z̅ can be sampled using Hₜ⁻¹ to form time-varying noise images {Zₜ}.

Minor stabilization errors, as well as exposure changes, vignetting, and radial distortion, usually cause slight changes in appearance even for a stationary background. If the background is assumed to be entirely static, these subtle shifts in appearance will show up as noise in the omnimatte. Such effects, however, tend to have low spatial and temporal frequency relative to the subject's effects and can be safely captured by applying a refinement warp to the background layer. The refinement warp can include a spatially and temporally coarse grid-based warp. Some example implementations additionally apply a grid-based brightness adjustment to the final composite Comp( [symbol] ₜ, oₜ). The parameters of the warp and brightness adjustment are optimized together with the network parameters.

### Example Implementation Details

Mask R-CNN (He et al., Mask R-CNN. In ICCV, 2017) can be used to segment the input objects, and STM (Oh et al., Video object segmentation using space-time memory networks. In ICCV, 2019) (a video object segmenter trained on the DAVIS dataset) can be used to track objects across frames. Optical flow between consecutive frames can be computed using RAFT (Teed and Deng. RAFT: Recurrent all-pairs field transforms for optical flow). When dynamic background elements such as tree branches are present, some example implementations use panoptic segmentation (Wu et al., Detectron2. https://girhub.com/facebookresearch/detectron2, 2019) to segment them and treat the segment as additional objects. To increase the detail of the color buffers Cₜⁱ, some example implementations can apply a similar detail-transfer technique to Lu et al., Layered neural rendering for retiming people in video. In SIGGRAPH Asia, 2020.

### Example Devices and Systems

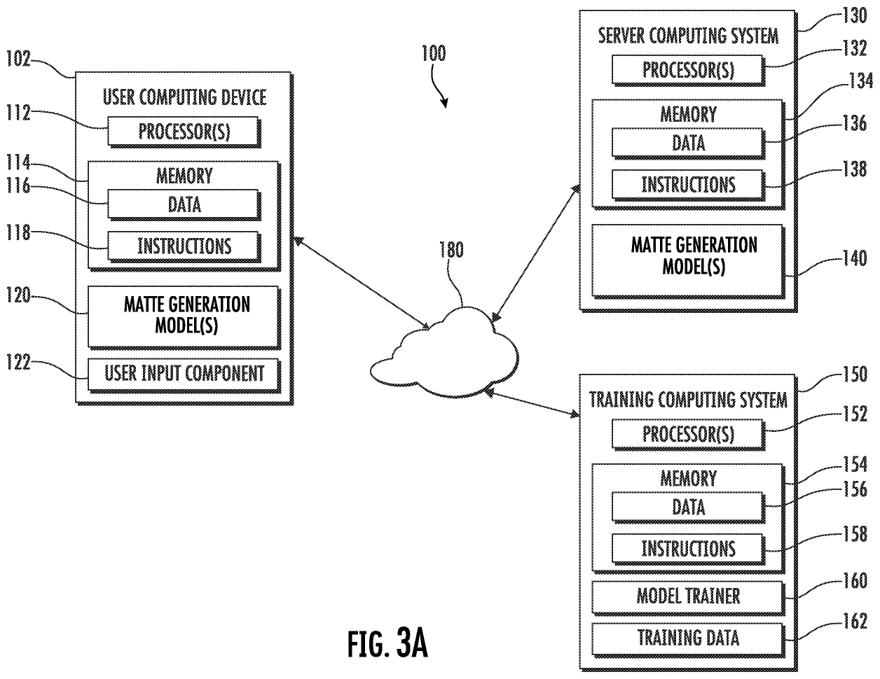

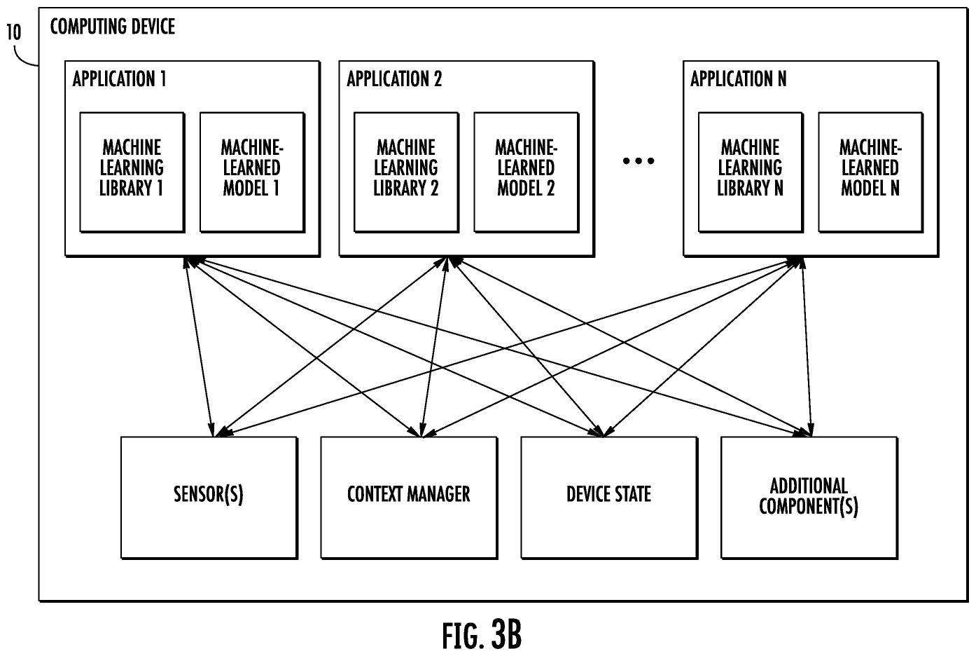

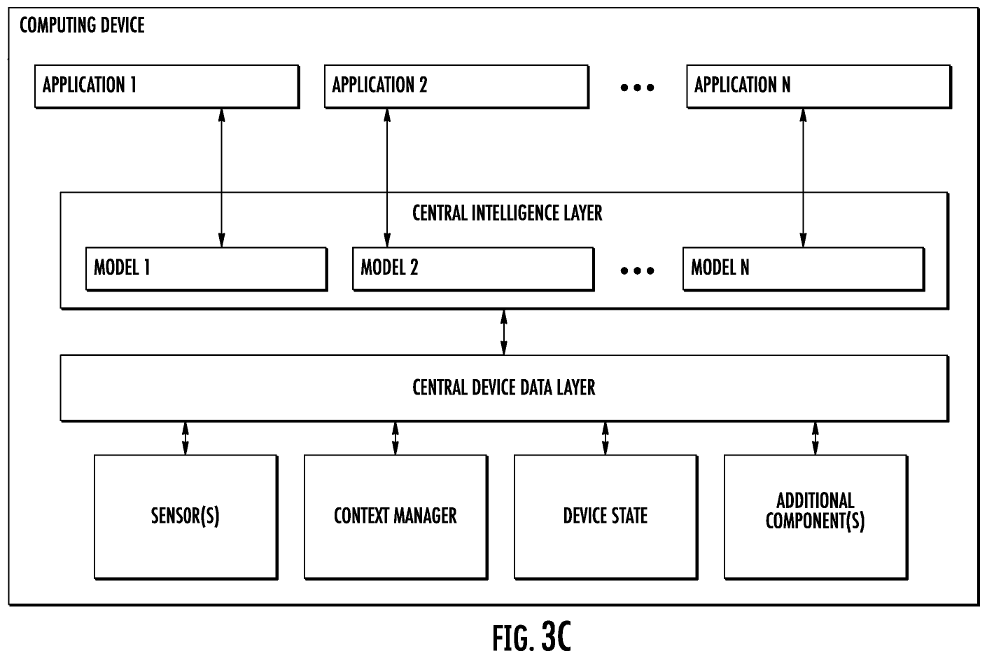

FIG. 3A depicts a block diagram of an example computing system 100 that performs object effect extraction according to example embodiments of the present disclosure. The system 100 includes a user computing device 102, a server computing system 130, and a training computing system 150 that are communicatively coupled over a network 180.

The user computing device 102 can be any type of computing device, such as, for example, a personal computing device (e.g., laptop or desktop), a mobile computing device (e.g., smartphone or tablet), a gaming console or controller, a wearable computing device, an embedded computing device, or any other type of computing device.

The user computing device 102 includes one or more processors 112 and a memory 114. The one or more processors 112 can be any suitable processing device (e.g., a processor core, a microprocessor, an ASIC, a FPGA, a controller, a microcontroller, etc.) and can be one processor or a plurality of processors that are operatively connected. The memory 114 can include one or more non-transitory computer-readable storage mediums, such as RAM, ROM, EEPROM, EPROM, flash memory devices, magnetic disks, etc., and combinations thereof. The memory 114 can store data 116 and instructions 118 which are executed by the processor 112 to cause the user computing device 102 to perform operations.

In some implementations, the user computing device 102 can store or include one or more matte generation models 120. For example, the matte generation models 120 can be or can otherwise include various machine-learned models such as neural networks (e.g., deep neural networks) or other types of machine-learned models, including non-linear models and/or linear models. Neural networks can include feed-forward neural networks, recurrent neural networks (e.g., long short-term memory recurrent neural networks), convolutional neural networks or other forms of neural networks. Example matte generation models 120 are discussed with reference to FIGS. 2 and 12-13.

In some implementations, the one or more matte generation models 120 can be received from the server computing system 130 over network 180, stored in the user computing device memory 114, and then used or otherwise implemented by the one or more processors 112. In some implementations, the user computing device 102 can implement multiple parallel instances of a single matte generation model 120 (e.g., to perform parallel object effect extraction across multiple instances of matte generation models 120).

More particularly, the matte generation model 120 can receive video data as input and decompose the video data into one or more layers, each layer associated with and containing primarily video data depicting one or more designated objects. For example, the matte generation model can generate one or more object maps (e.g., by an object map generation model) and wrap texture data to a deep texture map based on the object maps. Additionally, the matte generation model can associate trace effects in the video data with the objects that cause or otherwise affect the trace effects, and include the trace effects in a layer depicting a respective object.

Additionally or alternatively, one or more matte generation models 140 can be included in or otherwise stored and implemented by the server computing system 130 that communicates with the user computing device 102 according to a client-server relationship. For example, the matte generation models 140 can be implemented by the server computing system 140 as a portion of a web service (e.g., a object effect extraction service). Thus, one or more models 120 can be stored and implemented at the user computing device 102 and/or one or more models 140 can be stored and implemented at the server computing system 130.

The user computing device 102 can also include one or more user input component 122 that receives user input. For example, the user input component 122 can be a touch-sensitive component (e.g., a touch-sensitive display screen or a touch pad) that can be sensitive to the touch of a user input object (e.g., a finger or a stylus). The touch-sensitive component can serve to implement a virtual keyboard. Other example user input components include a microphone, a traditional keyboard, or other means by which a user can provide user input.

The server computing system 130 includes one or more processors 132 and a memory 134. The one or more processors 132 can be any suitable processing device (e.g., a processor core, a microprocessor, an ASIC, a FPGA, a controller, a microcontroller, etc.) and can be one processor or a plurality of processors that are operatively connected. The memory 134 can include one or more non-transitory computer-readable storage mediums, such as RAM, ROM, EEPROM, EPROM, flash memory devices, magnetic disks, etc., and combinations thereof. The memory 134 can store data 136 and instructions 138 which are executed by the processor 132 to cause the server computing system 130 to perform operations.

In some implementations, the server computing system 130 includes or can be otherwise implemented by one or more server computing devices. In instances in which the server computing system 130 includes plural server computing devices, such server computing devices can operate according to sequential computing architectures, parallel computing architectures, or some combination thereof.

As described above, the server computing system 130 can store or otherwise include one or more machine-learned matte generation models 140. For example, the models 140 can be or can otherwise include various machine-learned models. Example machine-learned models include neural networks or other multi-layer non-linear models. Example neural networks include feed forward neural networks, deep neural networks, recurrent neural networks, and convolutional neural networks. Example models 140 are discussed with reference to FIGS. 2 and 12-13.

The user computing device 102 and/or the server computing system 130 can train the models 120 and/or 140 via interaction with the training computing system 150 that can be communicatively coupled over the network 180. The training computing system 150 can be separate from the server computing system 130 or can be a portion of the server computing system 130.

The training computing system 150 includes one or more processors 152 and a memory 154. The one or more processors 152 can be any suitable processing device (e.g., a processor core, a microprocessor, an ASIC, a FPGA, a controller, a microcontroller, etc.) and can be one processor or a plurality of processors that are operatively connected. The memory 154 can include one or more non-transitory computer-readable storage mediums, such as RAM, ROM, EEPROM, EPROM, flash memory devices, magnetic disks, etc., and combinations thereof. The memory 154 can store data 156 and instructions 158 which are executed by the processor 152 to cause the training computing system 150 to perform operations. In some implementations, the training computing system 150 includes or can be otherwise implemented by one or more server computing devices.

The training computing system 150 can include a model trainer 160 that trains the machine-learned models 120 and/or 140 stored at the user computing device 102 and/or the server computing system 130 using various training or learning techniques, such as, for example, backwards propagation of errors. For example, a loss function can be backpropagated through the model(s) to update one or more parameters of the model(s) (e.g., based on a gradient of the loss function). Various loss functions can be used such as mean squared error, likelihood loss, cross entropy loss, hinge loss, and/or various other loss functions. Gradient descent techniques can be used to iteratively update the parameters over a number of training iterations.

In some implementations, performing backwards propagation of errors can include performing truncated backpropagation through time. The model trainer 160 can perform a number of generalization techniques (e.g., weight decays, dropouts, etc.) to improve the generalization capability of the models being trained.

In particular, the model trainer 160 can train the matte generation models 120 and/or 140 based on a set of training data 162. The training data 162 can include, for example, an external dataset video data. As one example, the training data 162 for an object map generation model can include a dataset curated to contain only single-person video frames. Another example dataset includes filmed video of approximately 10 minutes of a single person doing a variety of poses.

In some implementations, if the user has provided consent, the training examples can be provided by the user computing device 102. Thus, in such implementations, the model 120 provided to the user computing device 102 can be trained by the training computing system 150 on user-specific data received from the user computing device 102. In some instances, this process can be referred to as personalizing the model.

The model trainer 160 includes computer logic utilized to provide desired functionality. The model trainer 160 can be implemented in hardware, firmware, and/or software controlling a general purpose processor. For example, in some implementations, the model trainer 160 includes program files stored on a storage device, loaded into a memory and executed by one or more processors. In other implementations, the model trainer 160 includes one or more sets of computer-executable instructions that are stored in a tangible computer-readable storage medium such as RAM hard disk or optical or magnetic media.

The network 180 can be any type of communications network, such as a local area network (e.g., intranet), wide area network (e.g., Internet), or some combination thereof and can include any number of wired or wireless links. In general, communication over the network 180 can be carried via any type of wired and/or wireless connection, using a wide variety of communication protocols (e.g., TCP/IP, HTTP, SMTP, FTP), encodings or formats (e.g., HTML, XML), and/or protection schemes (e.g., VPN, secure HTTP, SSL).

FIG. 3A illustrates one example computing system that can be used to implement the present disclosure. Other computing systems can be used as well. For example, in some implementations, the user computing device 102 can include the model trainer 160 and the training dataset 162. In such implementations, the models 120 can be both trained and used locally at the user computing device 102. In some of such implementations, the user computing device 102 can implement the model trainer 160 to personalize the models 120 based on user-specific data.

FIG. 3B depicts a block diagram of an example computing device 10 that may perform, among other functions, object effect extraction according to example embodiments of the present disclosure. The computing device 10 can be a user computing device or a server computing device.

The computing device 10 includes a number of applications (e.g., applications 1 through N). Each application contains its own machine learning library and machine-learned model(s). For example, each application can include a machine-learned model. Example applications include a text messaging application, an email application, a dictation application, a virtual keyboard application, a browser application, etc.

As illustrated in FIG. 3B, each application can communicate with a number of other components of the computing device, such as, for example, one or more sensors, a context manager, a device state component, and/or additional components. In some implementations, each application can communicate with each device component using an API (e.g., a public API). In some implementations, the API used by each application can be specific to that application.

FIG. 3C depicts a block diagram of an example computing device 50 that performs according to example embodiments of the present disclosure. The computing device 50 can be a user computing device or a server computing device.

The computing device 50 includes a number of applications (e.g., applications 1 through N). Each application can be in communication with a central intelligence layer. Example applications include a text messaging application, an email application, a dictation application, a virtual keyboard application, a browser application, etc. In some implementations, each application can communicate with the central intelligence layer (and model(s) stored therein) using an API (e.g., a common API across all applications).

The central intelligence layer includes a number of machine-learned models. For example, as illustrated in FIG. 3C, a respective machine-learned model (e.g., a model) can be provided for each application and managed by the central intelligence layer. In other implementations, two or more applications can share a single machine-learned model. For example, in some implementations, the central intelligence layer can provide a single model (e.g., a single model) for all of the applications. In some implementations, the central intelligence layer can be included within or otherwise implemented by an operating system of the computing device 50.

The central intelligence layer can communicate with a central device data layer. The central device data layer can be a centralized repository of data for the computing device 50. As illustrated in FIG. 3C, the central device data layer can communicate with a number of other components of the computing device, such as, for example, one or more sensors, a context manager, a device state component, and/or additional components. In some implementations, the central device data layer can communicate with each device component using an API (e.g., a private API).

### Additional Disclosure

The technology discussed herein makes reference to servers, databases, software applications, and other computer-based systems, as well as actions taken and information sent to and from such systems. The inherent flexibility of computer-based systems allows for a great variety of possible configurations, combinations, and divisions of tasks and functionality between and among components. For instance, processes discussed herein can be implemented using a single device or component or multiple devices or components working in combination. Databases and applications can be implemented on a single system or distributed across multiple systems. Distributed components can operate sequentially or in parallel.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations and/or additions to the present subject matter as would be readily apparent to one of ordinary skill in the art. For instance, features illustrated or described as part of one embodiment can be used with another embodiment to yield a still further embodiment. Thus, it is intended that the present disclosure cover such alterations, variations, and equivalents.

1. A computer-implemented method for identifying and extracting object-related effects in videos, the computer-implemented method comprising:
obtaining, by a computing system comprising one or more computing devices, video data, the video data comprising a plurality of image frames depicting one or more objects; and
for each of the plurality of image frames:
generating, by the computing system, one or more binary object masks, wherein each of the one or more binary object masks is descriptive of a respective location of a corresponding object of the one or more objects within the image frame;
inputting, by the computing system, the image frame and the one or more binary object masks into a machine-learned matte generation model; and
receiving, by the computing system as output from the machine-learned matte generation model, a background layer illustrative of a background of the video data and one or more object layers respectively associated with the one or more binary object masks;
wherein each of the one or more object layers comprises image data illustrative of the corresponding object and one or more trace effects at least partially attributable to the corresponding object.

2. The computer-implemented method of claim 1, wherein the background layer and the one or more object layers comprise one or more color channels and an opacity matte.

3. The computer-implemented method of claim 1, wherein, for each corresponding object, at least a portion of the one or more trace effects have locations which different from the respective location of the corresponding object.

4. The computer-implemented method of claim 1, wherein, for each corresponding object, at least a portion of the one or more trace effects are time-varying effects.

5. The computer-implemented method of claim 1, wherein each of the one or more binary object masks is descriptive of the respective location of the corresponding object independent of and excluding the one or more trace effects.

6. The computer-implemented method of claim 1, wherein, for at least one of the corresponding objects, the one or more trace effects comprise a shadow, a reflection, smoke generated by the object, or a ripple.

7. The computer-implemented method of claim 1, further comprising, for each of the plurality of image frames:
generating, by the computing system and based at least in part on the one or more binary object masks, one or more object optical flows respectively for the one or more objects;
wherein inputting, by the computing system, the image frame and the one or more binary object masks into the machine-learned matte generation model comprises wherein inputting, by the computing system, the image frame, the one or more binary object masks, and the one or more object optical flows into the machine-learned matte generation model.

8. The computer-implemented method of claim 7, wherein each of the one or more object layers comprises a refined object optical flow for the corresponding object.

9. The computer-implemented method of claim 1, wherein at least one of the corresponding objects comprises a plurality of objects treated as a collective object.

10. The computer-implemented method of claim 1, wherein the machine-learned matte generation model comprises a neural network.

11. The computer-implemented method of claim 1, wherein the machine-learned matte generation model has been trained based at least in part on a reconstruction loss, a flow loss, and a regularization loss.

12. A computing system configured to decompose image data into a plurality of layers, the computing system comprising:
one or more processors; and
one or more non-transitory computer-readable media that store instructions that, when executed by the one or more processors, cause the computing system to perform operations, the operations comprising:
obtaining image data, the image data comprising one or more image frames depicting one or more objects; and
for each of the one or more image frames:
generating one or more binary object masks, wherein each of the one or more binary object masks is descriptive of a respective location of corresponding object of the one or more objects within the image frame;
inputting the image frame and the one or more binary object masks into a machine-learned matte generation model; and
receiving, as output from the machine-learned matte generation model, a background layer illustrative of a background of the image data and one or more object layers respectively associated with one of the one or more binary object masks;
wherein each of the one or more object layers comprises image data illustrative of the corresponding object and one or more trace effects at least partially attributable to the corresponding object.

13. The computing system of claim 12, wherein the background layer and the one or more object layers comprise one or more color channels and an opacity matte.

14. The computing system of claim 12, wherein, for each corresponding object, at least a portion of the one or more trace effects have locations which different from the respective location of the corresponding object.

15. The computing system of claim 12, wherein, for at least one of the corresponding objects, the one or more trace effects comprise a shadow, a reflection, smoke generated by the object, or a ripple.

16. One or more non-transitory computer-readable media that collectively store a machine-learned matte generation model, wherein the machine-learned matte generation model has been trained by performance of operations, the operations comprising:
obtaining, by a computing system comprising one or more computing devices, video data, the video data comprising a plurality of image frames depicting one or more objects; and
for each of the plurality of image frames:
generating, by the computing system, one or more binary object masks, wherein each of the one or more binary object masks is descriptive of a respective location of a corresponding object of the one or more objects within the image frame;
inputting, by the computing system, the image frame and the one or more binary object masks into a machine-learned matte generation model;
receiving, by the computing system as output from the machine-learned matte generation model, a background layer illustrative of a background of the video data and one or more object layers respectively associated with the one or more binary object masks, wherein each of the one or more object layers comprises image data illustrative of the corresponding object and one or more trace effects at least partially attributable to the corresponding object;
compositing the background layer and the one or more object layers to generate a reconstructed frame;
evaluating a loss function that comprises a reconstruction loss term that compares the reconstructed frame with the image frame; and
modifying one or more values of one or more parameters of the machine-learned matte generation model based on the loss function.

17. The one or more non-transitory computer-readable media of claim 16, wherein the background layer and the one or more object layers comprise one or more color channels and an opacity matte.

18. The one or more non-transitory computer-readable media of claim 16, wherein, for each of the plurality of image frames:
the operations further comprise generating, by the computing system and based at least in part on the one or more binary object masks, one or more object optical flows respectively for the one or more objects;
inputting, by the computing system, the image frame and the one or more binary object masks into the machine-learned matte generation model comprises wherein inputting, by the computing system, the image frame, the one or more binary object masks, and the one or more object optical flows into the machine-learned matte generation model;
each of the one or more object layers comprises a refined object optical flow for the corresponding object;
the operations further comprise compositing the refined object optical flows to generate a reconstructed flow map; and
the loss function further comprises a flow loss term that compares an original flow map with the reconstructed flow map.

19. The one or more non-transitory computer-readable media of claim 18, wherein the loss function further comprises an alpha warping loss term that compares an opacity matte of each object layer with a warped opacity matte for such object layer, the warped opacity matte for each object layer comprises a previous or subsequent opacity matte associated with the object layer in a previous or subsequence image frame which has been warped according to the refined object optical flow generated for such object layer.

20. The one or more non-transitory computer-readable media of claim 16, wherein the loss function further comprises a regularization loss term that encourages an opacity matte of each object layer toward sparsity.
